(19) United States
(12) Patent Application Publication
(10) Pub. No.: US 2007/0195878 A1
(43) Pub. Date: Aug. 23, 2007

(54) Device and method for receiving video data

(75) Inventors: Wilhelmus Hendrikus Alfonsus Bruls, Eindhoven (NL); Petrus Desiderius Victor Van Der Stok, Eindhoven (NL); Renatus Josephus Van Der Vleuten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,599

(22) PCT Filed: Mar. 24, 2005
(86) PCT No.: PCT/IB05/51022

§ 371 Date: Oct. 3, 2006

(30) Foreign Application Priority Data
Apr. 6, 2004 (EP) 04101417.6

(51) Int. Cl. H04B 1/66; H04N 11/02

(52) U.S. Cl. 375/240.1; 375/240.25

(57) ABSTRACT

The device and method according to the invention prevent that the consistency of image quality is negatively affected when transmission rate fluctuations occur on a communication channel. The invention relies on the perception that the transition from a full quality video signal to a basic-quality video signal, respectively from a basic-quality video signal to a full-quality video signal, should be a gradual transition instead of a sudden transition. The blending process can be implemented by circuitry which applies a blending factor on the decoded video signals of the base layer and the enhancement layer(s), before these decoded video signals are merged to form a single output video signal. Due to the delay time of the decoding process there will be a natural delay between the moment a transition occurs in the received video data and the moment that a transition occurs in the full-quality video signal. During that time interval the blending factor may be changed gradually, so that the visibility of the transition is reduced. It may be preferable to provide for an extra delay in addition to this natural delay. This enables the device to further smooth away the effect of the quality transition in the received video data.

The invention relates to a device for receiving video data, the video data comprising a base layer data and at least one enhancement layer data, the device being arranged to delay the base layer data and the enhancement layer data, the device also being arranged to decode the base layer data and the enhancement layer data into a full-quality video signal, the device further being arranged to decode only the base layer data into a basic-quality video signal.

The invention also relates to an in-home wireless connected system comprising such a device.

The invention further relates to a method for receiving video data, the video data comprising a base layer data and at least one enhancement layer data, wherein the base layer data and the enhancement layer data are delayed, wherein the base layer data and the enhancement layer data are decoded into a full-quality video signal, and wherein the base layer data is decoded into a basic-quality video signal.

It is widely recognized that digital television technology becomes increasingly important. Using digital TV technology, the image quality of transmitted television programs can be increased significantly. This improvement can be achieved by increasing the resolution of the transmitted images. For example, the effective resolution of a normal analog TV amounts to about 512×400 pixels, whereas the resolution of a digital TV can amount to 1920×1080 pixels or more.

The transmission of digital TV signals consisting of large data streams imposes a large burden on the bandwidth and storage requirements of digital TV transmitters and receivers. In order to decrease these bandwidth and storage requirements, attempts have been made to compress the data streams such that less data can be transmitted without losing image quality. For example, widely deployed compression schemes are MPEG-2 and MPEG-4, which are international standards propagated by the Moving Picture Experts Group (MPEG). The MPEG-2 and MPEG-4 compression schemes reduce the bit rate of the video streams, so that a maximum amount of video information can be transmitted with a given communication and storage capacity.

A problem of such compression schemes is that the decoding of high-resolution video requires a much higher computational complexity than what is required for low-resolution video. The consequences are that high-resolution decoders are significantly more expensive than low-resolution decoders, and that nowadays low-resolution decoders still have a considerable market share. Furthermore, high-resolution video requires a higher bit rate, which can be a major problem if the transmission capacity is limited. Typical applications in which the transmission capacity is limited and in which the available bandwidth may fluctuate are in-home wireless connections and streaming video on the Internet. For these reasons, it is desirable to provide support for delivery of the same video content both in the format of low-resolution video and in the format of high-resolution video.

An example of a technique to achieve delivery of video content in two formats is the so-called spatially scalable video coding scheme or dual-layer video coding scheme. Dual-layer video coding uses a base layer, which represents the low-resolution video content, and one or more enhancement layers, which represent the high-resolution video content. The base layer can be transmitted at a significantly lower bit rate than the enhancement layers, and consequently the communication and storage requirements for the base layer are much less stringent. Lower-capacity receivers can for example receive the base layer, while higher-capacity receivers can in addition receive the enhancement layers. In general terms, it is desirable to have a system with multiple layers, which system comprises one basic-quality layer and at least one additional layer, wherein each additional layer adds a level of quality to a previous layer.

U.S. Pat. No. 6,510,177 discloses a dual-layer video coding scheme which is enhanced to decrease the loss of compression efficiency for the high-resolution video representation, which loss is relative to a separate encoding of the high resolution video using the same total bit rate but without the dual-layer structure. This is achieved by using motion vectors transmitted in the base layer to decode the enhancement layer.

It is noted that a stream, a video stream or a stream of video data is defined as a stream of bits which must be decoded, resulting in a decoded video signal which comprises a sequence of images. A disadvantage of the dual-layer video coding scheme is that noticeable quality transitions can occur at the receiving side when the transmission rate fluctuates, e.g. when—at a first instant—a full-quality video signal (base layer+enhancement layers) is displayed and subsequently—at a second instant—a basic-quality video signal (base layer only) is displayed because the communication channel cannot transmit the complete video stream at the second instant. After a while, when the communication channel is able to transmit the whole video stream again, a noticeable quality transition from a basic-quality video signal to a full-quality video signal can also occur. Particularly if connections with a limited transmission capacity are used (such as in-home wireless connections), then these quality transitions can have a negative effect on the consistency of the image quality perceived by a user.

It is an object of the invention to provide a device and a method for receiving video streams of the kind set forth, which device and method prevent that the consistency of the image quality is negatively affected when transmission rate fluctuations occur. This object is achieved by providing a device characterized by the characterizing portion of claim 1. The object is also achieved by providing a method characterized by the characterizing portion of claim 9.

The invention relies on the perception that the transition from a full-quality video signal to a basic-quality video signal, respectively from a basic-quality video signal to a full-quality video signal, should be a gradual transition instead of a sudden transition. The blending process can be implemented by circuitry which applies a blending factor on the decoded video signals of the base layer and the enhancement layer(s), before these decoded video signals are merged to form a single output video signal.

Due to the delay time of the decoding process there will be a natural delay between the moment a transition occurs in the received video data and the moment that a transition occurs in the full-quality video signal. During that time interval the blending factor may be changed gradually, so that the visibility of the transition is reduced. It may be preferable to provide for an extra delay in addition to this natural delay. This enables the device to further smooth away the effect of the quality transition in the received video data.

The embodiment defined in claim 2 is arranged to blend a basic-quality video signal with a full-quality video signal, when only the base layer data is received in a first instant and both the base layer data and the enhancement layer data is received in a subsequent instant.

The embodiment defined in claim 3 provides additional delay elements which are arranged to delay the base layer data and the enhancement layer data. This is useful to further smooth away the quality transitions during transmission fluctuations; the delay elements introduce an extra delay in addition to the ‘natural’ delay which is already caused by the decoding process.

The embodiment defined in claim 4 provides an example of an implementation of the device according to claim 1. This embodiment comprises a first multiplier unit, a second multiplier unit and an add unit, wherein the first multiplier unit is arranged to apply a blending factor to the basic-quality video signal, wherein the second multiplier unit is arranged to apply a complementary blending factor to the full-quality video signal, and the add unit is arranged to combine the resulting basic-quality output signal with the resulting full-quality output signal into a single output signal.

The embodiment defined in claim 5 is a further implementation of the device according to claim 4, which device is further arranged to adapt the blending factor as time proceeds, wherein the device is triggered to increase the blending factor when the enhancement layer data is no longer received, and wherein the device is triggered to decrease the blending factor when the enhancement layer data is received again.

In the embodiment defined in claim 6, the basic-quality video signal represents a sequence of images with a relatively low resolution, and the full-quality video signal represents a sequence of images with a relatively high resolution.

The embodiment defined in claim 7 comprises a comprises a spatial-sharpness improvement unit, the spatial-sharpness improvement unit being arranged to up-scale the basic-quality video signal, and the spatial-sharpness improvement unit further being arranged to improve the spatial sharpness of the images represented by the basic-quality video signal. In this manner, the quality of the basic-quality video signal is improved so that the quality transition between the full-quality video signal and the basic-quality video signal will be less noticeable.

Since the device according to the invention is particularly useful for deployment in in-home wireless connected systems, claim 8 defines an in-home wireless connected system comprising such a device.

The present invention is described in more detail with reference to the drawings, in which:

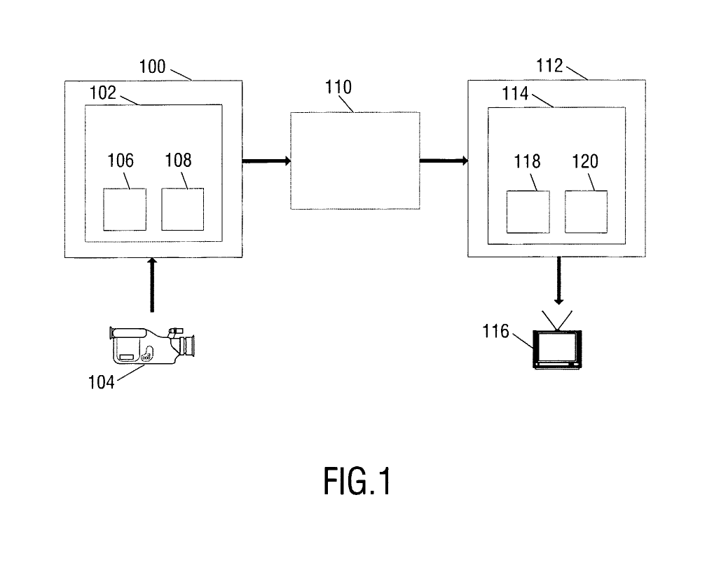

FIG. 1 illustrates a known system for transmitting digital video streams;

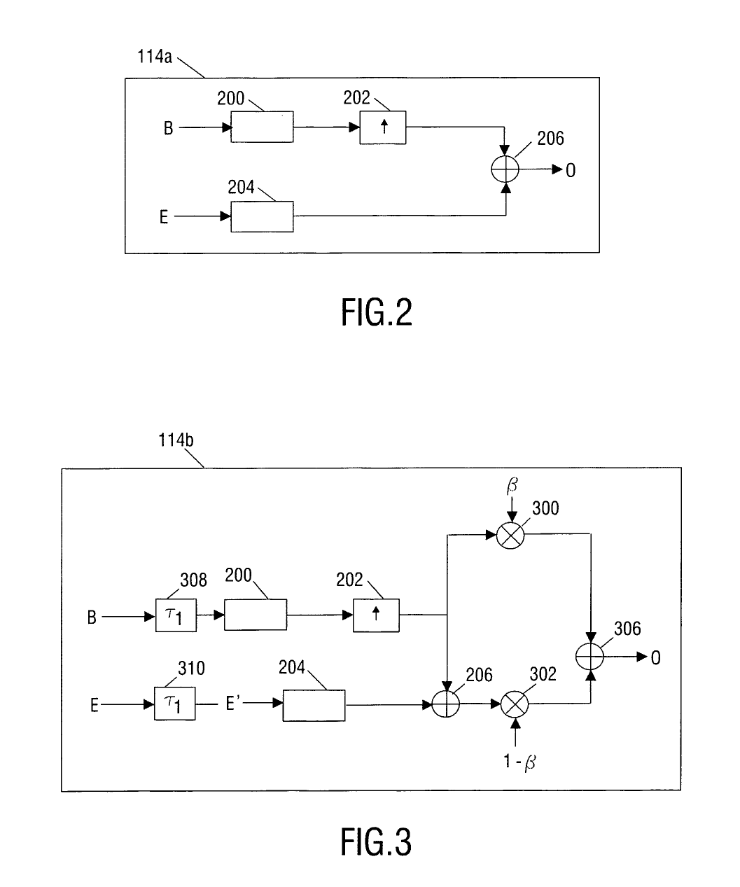

FIG. 2 illustrates a known dual-layer video decoder;

FIG. 3 illustrates a dual-layer video decoder according to the invention;

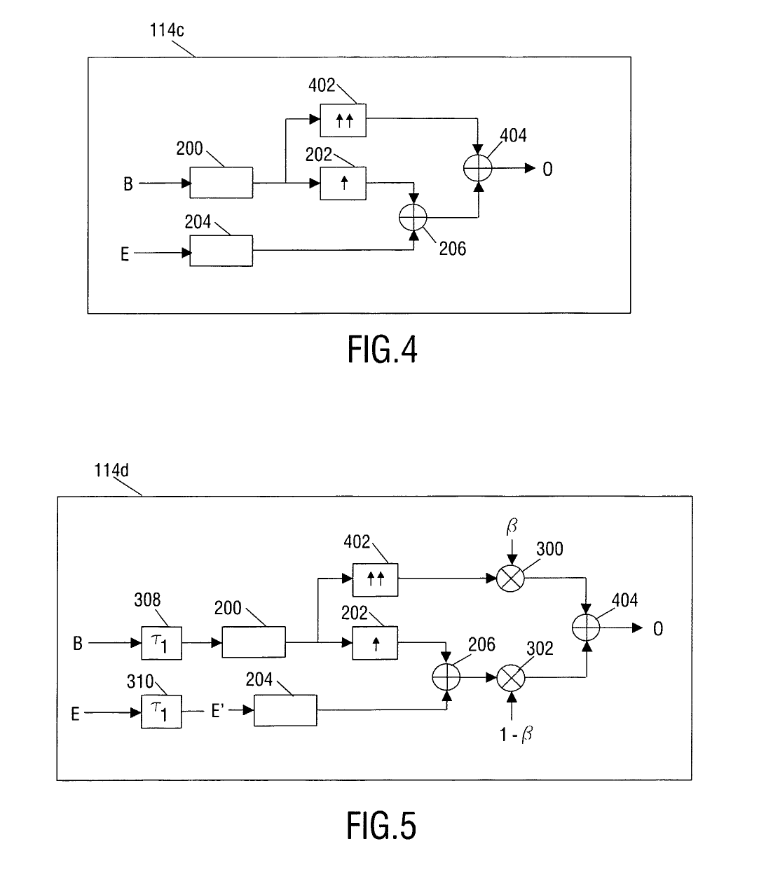

FIG. 4 illustrates a known dual-layer video decoder comprising a circuit for sharpness improvement;

FIG. 5 illustrates a dual-layer video decoder comprising a circuit for sharpness improvement according to the invention;

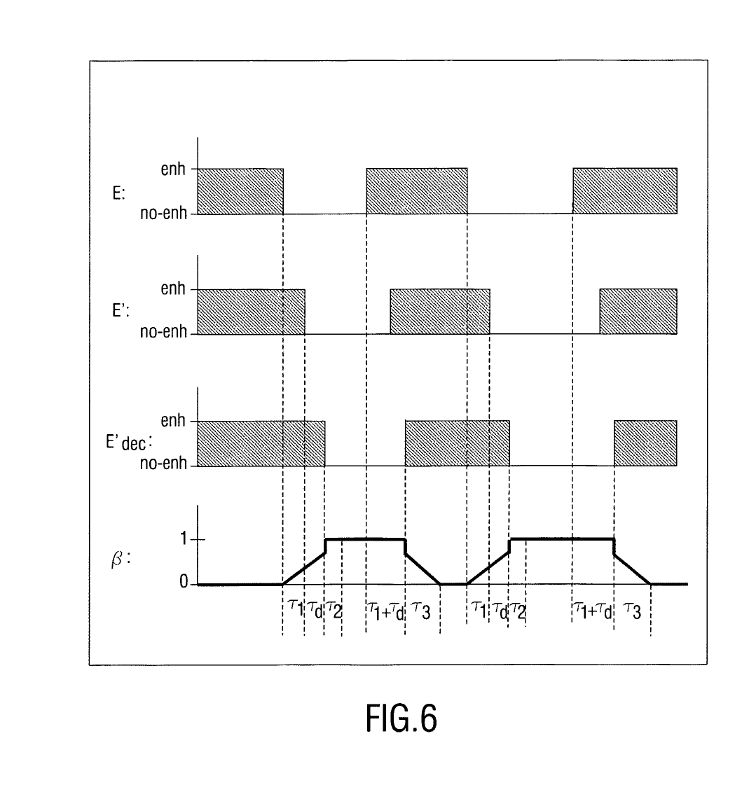

FIG. 6 illustrates a timing diagram corresponding to the dual-layer video decoder which is illustrated in FIG. 5.

FIG. 1 illustrates a known system for transmitting digital video streams. On the transmitting side, there is a transmitter 100 which includes a layered video encoder 102. The layered video encoder 102 comprises a base-layer module 106 and an enhancement-layer module 108. The base-layer module 106 encodes the video stream for transmission at a relatively low bit rate and provides a so-called base layer, while retaining a basic quality of the encoded images in the video stream. The enhancement-layer module 108 typically encodes complementary information about the image (e.g. more pixels than the base layer) and provides at least one enhancement layer. Alternatively, a plurality of enhancement-layer modules may exist in the system, each of which encodes a type of complementary information about the images in the video stream. The transmitter 100 receives its input from a video source 104, which may be a digital video camera or another device capable of producing digital video images.

The transmitter 100 transmits the encoded video stream over a communication channel 110 to a receiver 112. The encoded video stream may consist of various signals, each signal representing a layer (base layer or enhancement layer) of the video stream. The number of layers which can be transmitted in a certain unit of time depends on the available bandwidth of the communication channel 110. At certain instants all layers may be transmitted successfully, whereas at other instants only the base layer can be transmitted. An appropriate communication protocol is used to make sure that the base layer is always correctly delivered to the receiver 112, so that the receiver is always capable of decoding at least a stream of images with basic quality. Assuming that there is a base layer and only one enhancement layer, the communication protocol may have the following form:
transmit the base layer;
if receipt of the base layer is acknowledged, then transmit the enhancement layer, else retransmit the lost packets of the base layer until receipt of the base layer is acknowledged or until time runs out;
if receipt of the enhancement layer is acknowledged, then proceed with the successive image in the video stream, else retransmit the lost packets of the enhancement layer until receipt of the enhancement layer is acknowledged or until time runs out.

On the receiving side, the signals carrying the respective layers of the video stream are received by a receiver 112 which comprises a layered video decoder 114. The layered video decoder 114 comprises a base-layer decoder module 118 and an enhancement-layer decoder module 120. The base-layer decoder module 118 decodes the base-layer stream into a decoded base-layer video signal comprising a sequence of images with basic quality. The enhancement-layer decoder module 120 decodes one or more enhancement-layer streams containing complementary image information, resulting in one or more decoded enhancement-layer video signals. The layered video decoder 114 merges the decoded base-layer video signal with the decoded enhancement-layer video signal(s), i.e. the layered video decoder merges the output from the base-layer decoder module 118 and the enhancement-layer decoder module into a single output video signal comprising a sequence of images with full quality.

As the case may be, transmission rate fluctuations can occur and the available bandwidth at a certain instant is not sufficient to transmit both the base-layer stream and the enhancement-layer stream(s). In a real-time application such as streaming video, the above-mentioned communication protocol determines that only the base-layer stream is transmitted if the transmission rate is substantially low for a certain amount of time. Hence, quality fluctuations can occur when the transmission rate fluctuates. In a sequence of images, it may happen that a first image has a full quality and a successive image only has a basic quality. This has a clear negative effect on the consistency of the image quality of the output video signal. A transition back from an image with a basic quality to an image with a full quality can also have such a negative effect, although the effect is not so strong because an improvement of the video quality is less annoying than a deterioration of the video quality. Nevertheless, also in the latter case it would be better to smooth away the quality transitions, such that the video signal has a relatively constant image quality.

FIG. 2 illustrates a known dual-layer video decoder 114a, which is an example of a layered video decoder 114. The dual-layer video decoder 114a comprises:
a base layer decoder 200 which decodes the base-layer stream received as input signal B, resulting in a decoded base-layer video signal;
an up-scale unit 202 which up-scales the decoded base-layer video signal to a higher resolution;
an enhancement-layer decoder 204 which decodes the enhancement-layer stream received as input signal E, resulting in a decoded enhancement-layer video signal;
an add unit 206 which merges the up-scaled decoded base-layer video signal with the decoded enhancement-layer video signal, to form a single output video signal with full quality.

The resulting video signal is output as output signal O. Note that signal E is preferably, but not always transmitted. If signal E is not transmitted due to e.g. a lack of available bandwidth, then the output signal O merely consists of a basic-quality video signal formed by the up-scaled decoded base-layer video signal. The quality transition from a first image with full quality to a successive image with basic quality can be very sudden and may appear as a crude change in a sequence of images with otherwise constant quality.

FIG. 3 illustrates a dual-layer video decoder 114b according to the invention. In this case, the dual-layer video decoder 114b comprises all components 200, 202, 204, 206, of prior-art decoder 114a. Additionally, dual-layer video decoder 114b comprises multiplier units 300, 302 and another add unit 306. Alternatively, the dual-layer video decoder may comprise another type of mixing device (not shown). A first of the multiplier units 300 receives the up-scaled decoded base-layer video signal as a first input signal (which represents a basic-quality image), and it receives a second input signal β which represents a blending factor. The values of the blending factor β can be defined in a table; the blending factor β is defined as a function of time. A second of the multiplier units 302 receives the up-scaled decoded base-layer video signal combined with the decoded enhancement-layer video signal as a first input signal (which represents a full-quality image), and it receives a second input signal 1-β which represents the complementary blending factor.

A gradual transition from a full-quality video signal to a basic-quality video signal (and vice versa) can be achieved by steadily adjusting the blending factor as time proceeds. This technique can be illustrated by the following simplified example (not shown):
in a first instant (i.e. T₁) both signals B and E are received, in which case the value of β is set on ‘0’: a complete full-quality video signal is output as a first output signal O₁;
in a second instant (i.e. T₂) only signal B is received, in which case the value of β can be set on ‘0.5’: half of a full-quality video signal is merged with half of a basic-quality video signal to form a second output signal O₂ (note that the full-quality video signal must be composed using the decoded base-layer and enhancement-layer video signals retained from T₁ by means of e.g. buffer units (not shown) comprised in the base-layer decoder 200 and the enhancement-layer decoder 204);
in a third instant (i.e. T₃) again only signal B is received, in which case the value of β can be set on ‘1’: a complete basic-quality video signal is output as a third output signal O₃.

It can be seen from the above example that a quality transition, which would occur in a single step using the prior-art video decoder 114a, now occurs in two steps. This results in a more gradual quality transition in the output video signal. It is evident that many more steps can be used to make the quality transition as smooth as possible. In practice, the blending factor β will be changed in many small steps, so that the change resembles a continuous change instead of a number of discrete adjustment steps.

The video decoder 114b according to the invention enables fine-tuning of the quality transition; the degree of fine-tuning depends on the quality requirements imposed by a specific streaming video application.

FIG. 4 illustrates a known dual-layer video decoder 114c comprising a circuit for sharpness improvement 402. This is an example of a video decoder which uses spatial-sharpness improvement techniques to improve the sharpness of the output images. These techniques may use forms of peaking and transient improvement. For this purpose there are well-known technologies available on the market, e.g. a technology with the trade name Pixel Plus. The up-scaled decoded base-layer video signal combined with the decoded enhancement-layer video signal is merged with an up-scaled and spatial-sharpness improved version of the decoded base-layer video signal.

FIG. 5 illustrates a dual-layer video decoder 114d comprising a circuit for sharpness improvement 402 according to the invention. Also in this case, the dual-layer video decoder 114d comprises multiplier units 300, 302. A first of the multiplier units 300 receives the up-scaled and spatial-sharpness improved decoded base-layer video signal as a first input signal (which represents a basic-quality image with improved sharpness), and it receives a second input signal β which represents a blending factor. A second of the multiplier units 302 receives the up-scaled decoded base-layer video signal combined with the decoded enhancement-layer video signal as a first input signal (which represents a full-quality image), and it receives a second input signal 1-β which represents the complementary blending factor. Again, a gradual transition from a full-quality video signal to a basic-quality video signal with improved sharpness (and vice versa) can be achieved by steadily adjusting the blending factor as time proceeds.

Furthermore, the dual-layer video decoder 114d can be equipped with delay elements 308, 310. These delay elements 308, 310 facilitate the blending process by delaying the base-layer signal B and the enhancement-layer signal E. The delayed signals can be used to further improve the appearance of a smooth transition from a full-quality video signal to a basic-quality video signal (and vice versa). This will be explained with reference to FIG. 6.

FIG. 6 illustrates a timing diagram corresponding to the dual-layer video decoder 114d which is illustrated in FIG. 5. The base-layer input signal B and the enhancement-layer input signal E are delayed an equal amount of time τ₁. When the enhancement-layer input signal E is interrupted (e.g. due to a lack of available bandwidth), the video decoder 114d is triggered to gradually increase the blending factor β from ‘0’ to ‘1’ in order to achieve the aforementioned gradual transition from a full-quality video signal to a basic-quality video signal. As mentioned, the quality transition can be made even smoother by delaying both the base-layer input signal B and the enhancement-layer input signal E with a delay τ_{1.} The delayed enhancement-layer input signal E′ represents the enhancement-layer input signal E delayed by τ₁.

The delayed enhancement-layer input signal E′ (also referred to as delayed enhancement-layer stream) is decoded into a decoded enhancement-layer video signal E′_{dec}. This decoding process also introduces a delay τ_{d}, which is the ‘natural’ delay caused by the decoding and buffering process. Because the time interval wherein the quality transition occurs is reduced, the quality transition is less noticeable and the consistency of the image quality improves significantly. Due to the explicit delay τ₁ and the ‘natural’ delay τ_{d}, the actual quality transition will occur in the time interval τ₂ instead of the time interval τ₁+τ_{d}+τ₂, as can be seen from the timing diagram. The quality transition from a basic-quality video signal back to a full-quality video signal is made less noticeable by gradually decreasing the blending factor β in the time interval τ₃.

The techniques described herein can be combined with other techniques, for example with a method to split up the base layer information in two or more packages and the enhancement layer in two or more packages. The communication protocol is then adapted to transmit these base layer packages and enhancement layer packages separately. Again assuming that there is a base layer and only one enhancement layer, the communication protocol may then have the following form:
transmit the first package of the base layer;
if receipt of the first package of the base layer is acknowledged, then transmit the second package of the base layer, else retransmit the lost packets of the first package of the base layer until receipt of the first package of the base layer is acknowledged or until time runs out;
if receipt of the second package of the base layer is acknowledged, then transmit the first package of the enhancement layer, else retransmit the lost packets of the second package of the base layer until receipt of the second package of the base layer is acknowledged or until time runs out;
if receipt of the first package of the enhancement layer is acknowledged, then transmit the second package of the enhancement layer, else retransmit the lost packets of the first package of the enhancement layer until receipt of the first package of the enhancement layer is acknowledged or until time runs out;
if receipt of the second package of the enhancement layer is acknowledged, then proceed with the successive image in the video stream, else retransmit the lost packets of the second package of the enhancement layer until receipt of the second package of the enhancement layer is acknowledged or until time runs out.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. A device (114b, 114d) for receiving video data, the video data comprising a base layer data (B) and at least one enhancement layer data (E), the device (114b, 114d) being arranged to delay the base layer data (B) and the enhancement layer data (E), the device (114b, 114d) also being arranged to decode the base layer data (B) and the enhancement layer data (E) into a full-quality video signal, the device (114b, 114d) further being arranged to decode only the base layer data (B) into a basic-quality video signal, characterized in that the device (114b, 114d) is arranged to gradually blend the full-quality video signal with the basic-quality video signal when a first transmission fluctuation occurs, the first transmission fluctuation being defined as receiving the base layer data (B) and the enhancement layer data (E) in a first instant, and receiving only the base layer data (B) in a subsequent instant.

2. A device (114b, 114d) according to claim 1, wherein a second transmission fluctuation occurs when receiving only the base layer data (B) in a first instant, and receiving the base layer data (B) and the enhancement layer data (E) in a subsequent instant, the device (114b, 114d) being arranged to gradually blend the basic-quality video signal with the full-quality video signal when the second transmission fluctuation occurs.

3. A device (114b, 114d) according to claim 1, the device (114b, 114d) comprising a first delay element (308) and a second delay element (310), wherein the first delay element (308) is arranged to delay the base layer data (B), and wherein the second delay element (310) is arranged to delay the enhancement layer data (E).

4. A device (114b, 114d) as claimed in claim 1, the device comprising a first multiplier unit (300), a second multiplier unit (302) and an add unit (306), wherein the first multiplier unit (300) is arranged to apply a blending factor (β) to the basic-quality video signal, wherein the second multiplier unit (302) is arranged to apply a complementary blending factor (1-β) to the full-quality video signal, the add unit (306) being arranged to combine the resulting basic-quality output signal with the resulting full-quality output signal into a single output signal.

5. A device (114b, 114d) according to claim 4, the device further being arranged to adapt the blending factor (β) as time proceeds, wherein the device is triggered to increase the blending factor (β) when the enhancement layer data (E) is no longer received, and wherein the device is triggered to decrease the blending factor (β) when the enhancement layer data (E) is received again.

6. A device (114b, 114d) according to claim 1, wherein the basic-quality video signal represents a sequence of images with a relatively low resolution, and wherein the full-quality video signal represents a sequence of images with a relatively high resolution.

7. A device (114b, 114d) according to claim 1, the device (114b, 114d) further comprising a spatial-sharpness improvement unit (402), the spatial-sharpness improvement unit (402) being arranged to up-scale the basic-quality video signal, the spatial-sharpness improvement unit (402) further being arranged to improve the spatial sharpness of the images represented by the basic-quality video signal.

8. An in-home wireless connected system comprising a device (114b, 114d) according to claim 1.

9. A method for receiving video data, the video data comprising a base layer data (B) and at least one enhancement layer data (E), wherein the base layer data (B) and the enhancement layer data (E) are delayed, wherein the base layer data (B) and the enhancement layer data (E) are decoded into a full-quality video signal, and wherein the base layer data (B) is decoded into a basic-quality video signal, characterized in that the method gradually blends the full-quality video signal with the basic-quality video signal when a first transmission fluctuation occurs, the first transmission fluctuation being defined as receiving the base layer data (B) and the enhancement layer data (E) in a first instant, and receiving only the base layer data (B) in a subsequent instant.
